(19) United States
(12) Patent Application Publication
(10) Pub. No.: US 2007/0097669 A1
(43) Pub. Date: May 3, 2007

(54) Adaptor for capturing screen images from handheld video game devices and handheld video player devices and transmitting said images to a television or computer monitor

(76) Inventor: Man Pun Hui, Hong Kong (HK)

Correspondence Address: ERIC HANSCOM, 7395 PORTAGE WAY, CARLSBAD, CA, 92011, US

(21) Appl. No.: 11/282,006

(22) Filed: Nov. 18, 2005

Related U.S. Application Data
(60) Provisional application No. 60/732,277, filed on Nov. 1, 2005.

(51) Int. Cl. F21V 33/00

(52) U.S. Cl. 362/109; 362/85

(57) ABSTRACT

This invention is directed toward an adapter that transmits the screen image from a handheld video game device or handheld video player to a television or computer monitor without requiring the user to open the handheld and thereby void the warranty. The invention clips onto the back of the handheld and uses a precision lens and mirror system or a direct capture method to capture the image and light from the handheld screen. The invention then converts this image into a video signal via a camera, and the signal (AV, SVideo, VGA, NTCS/PAL, USB, etc.) is sent through video leads from the invention to an output for a computer monitor or to a TV set. Power for the invention comes through a standard electrical plug and/or batteries. Additional features include multiple camera modes, focus and brightness adjustments, adaptability to NTSC and PAL modes, and plastic console holder for easy installation.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

This invention is directed toward an adapter that transmits the screen image from a handheld video game device or a handheld video player device (hereinafter referred to as “handheld” or “handhelds”) to a TV or a computer monitor without requiring the user to open the handheld and thereby void the warranty, or modify the handheld in any way. The invention clips onto the back of the handheld and uses a precision lens and mirror system to capture the image and light from the handheld screen. A camera then converts this image into a video signal that is sent through video leads from the invention to a USB output for a computer monitor or directly to a TV set. Power for the invention comes through a standard electrical plug and/or batteries. Additional features include multiple camera modes, focus and brightness adjustments, adaptability to NTSC and PAL modes, and plastic console holder for easy installation.

Video game playing machines are one of the largest selling lines of home entertainment in the world. Video game machines began as huge, clunky stands which housed a screen and some crude, hand controls by which a user manipulated a figure in a video game. Over the years, four main companies—first Nintendo, Sony and Sega, and later Microsoft—developed smaller, portable console machines that hooked into a television and had controllers which the users would hold in their hands to control game play. The main advantage of these console units was that no longer did a video playing enthusiast have to walk to the local arcade to play video games, he or she could now play video games at home. Indeed the console could be transported from one person's house to another, or even take with a person during travels. A disadvantage with the consoles, however, was that although they were portable, they were, relative to the handheld video game devices, too large, heavy and bulky for convenient travel, they required too much energy to run off batteries for an appreciable amount of time, and they needed to be hooked up to a TV or computer monitor. Thus, the consoles were not easily transported and could be used while a person was not able to hook up to a convenient TV screen or monitor. So, the bored video game enthusiast waiting at an airport for two hours before his or her flight or driving with the family for several hours on vacation could not play a favorite video game to pass the time.

For some, this may seem to be a trivial problem compared to those faced by prior generations—such as the actual lives of the medieval peasants and warriors portrayed in many popular video games—but for the average video game enthusiasts (and the multi-billion dollar industry they support), this situation was an unspeakable tragedy of catastrophic proportions. Many parents of such video game addicts—excuse me, enthusiasts—also sought the same type of electrical pacifier during times of travel and driving that they bemoaned around the house when their child wished to play video games for 18 hours straight as opposed to partaking in the sports, hobbies and social activities that the parents had grown up believing were a normal part of a normal childhood. Thus the console begat the handheld video game device, and there was peace during times of waiting and times of travel.

The handheld video game device was the next step in the evolution of video game machines. These handhelds were small machines, easily held in a person's hand, which had their own screen and small buttons on the actual machine allowed a user to play the games. The first major handheld was the GameBoy by Nintendo, which ruled the handheld market for a decade without substantial challenge for shelf space and video game creative talent. For many years, Sony attracted a loyal following with the PlayStation line of products, and left the handheld video game market to Nintendo and its GameBoy line.

Recently, however, Sony entered the handheld arena with its PSP or PlayStation Portable, which has become quite popular.

Video game players are not the only electrical entertainment devices to follow to maxim that smaller is better. The iPod by Apple represents another line of video playing devices which can by used by a traveling person to play video on a small, easily transported screen. With portable, handheld video game and video playing devices grabbing an ever-growing part of the shelf space of our hearts and retail stores, it is only a matter of time before more mediums of entertainment make their way to handheld sizes.

One problem with the handheld video game and other devices such as the iPod video player is that the screen is quite small. While a small screen is necessary for the normal use of a handheld video machine—namely, traveling and carrying the video machine on trips—there are other times when a user wishes to play a game or watch video on the handheld unit while at home or another location with a television, and it would be advantageous for the user to be able to project the relatively tiny screen images onto the nearby TV. In a sort of reverse technological drift, there is now a need for allowing people to take the small screen images and be able to use them on the very televisions and monitors which were so bulky that their lack of easy transportation created the need for the handheld line of devices in the first place.

Thus was created the problem of how to get the contents normally displayed on the screen of a handheld onto at TV. Because there are frequently a wide variety of plugs and cables of different sizes which lead to and from, and in and out, of TV's, computer monitors and handheld machines, it was difficult to produce any kind of universal handheld-to-TV and handheld-to-computer monitor cable or cable combination. It therefore became imperative to find some sort of universal solution by which a user of a handheld could project the screen image to a nearby TV or computer monitor.

The prior has several examples of attempts to resolve this problem, namely, devices which allowed a user to “break in” to his or her handheld and wire it to the TV or a computer screen. In the hands of an inexperienced or mechanically-challenged user, the opening of a delicate handheld device may result in damaging or destroying the internal electronic components. Unfortunately, even when performed by an expert installer, breaking the seal on most handhelds voids the warranty, which was an obviously unsatisfactory result.

Thus there has existed a long-felt need for a device which could successfully capture the screen image of a handheld video game device or handheld video player and transmit it to a TV or computer screen without requiring the owner of the handheld console to open it up.

The current invention provides just such a solution by creating a device which can transmit the screen image from a handheld video game device or handheld video player to a TV or computer monitor without requiring the user to open the handheld and thereby void the warranty. While the Sony PSP handheld is used for illustration purposes in this application, the invention can work equally well with any other handheld, including the GameBoy handheld video game device line of products by Nintendo, the NDS, the iPod video player by Apple, and other handheld video game devices and handheld video players, as well as future handheld entertainment devices not yet invented which have a relatively small screen. The invention clips onto the back of the handheld and uses a precision lens and mirror system or a direct capture method to capture the image and light from the handheld screen and transmit it to a camera, which can be a standard camera, CCD or CMOS. The invention then converts this image into a video signal which can be AV, SVideo, VGA, NTSC/PAL, USB, etc., that is sent through video leads from the invention to a TV set or computer monitor. Power for the invention comes through a standard electrical plug and/or batteries. Additional features include multiple camera modes, focus and brightness adjustments, adaptability to NTSC and PAL modes, and plastic console holder for easy installation.

### SUMMARY OF THE INVENTION

It is a principal object of the invention to allow a user to view the screen of a handheld video game device or handheld video player on a TV screen or computer monitor.

Further Objects of the Invention Include:

An ability to capture the video image from a handheld without opening the handheld body and thereby voiding the warranty.

That the device consist of a few simple parts—namely a mirror, a camera, a power source, a power adapter input, and a housing with means of attachment to the handheld—such that the device is easy to construct and inexpensive to manufacture.

That there are at least two possible camera modes, including CMOS and CCD.

That there is means of adjusting the focus and the brightness.

That the device has means of switching between NTSC and PAL modes such that the device can be used in different countries with different television systems.

That the device can run off AC/DC in a variety of current voltages, DC, or batteries.

That the device has an easy means of attachment to the handheld, which may optimally comprise a plastic console holder for easy installation.

That the device can transmit its video signal to either a TV or to a USB output, where the signal can be used for other purposes such as display on a computer monitor.

It is a final object of this invention to provide an easy-to-use and inexpensive way to project the screen image of a handheld video game device or handheld video player onto a TV or computer screen for the entertainment of more people than just the user of the handheld.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

Views have been numbered as follows:

FIG. 1 is a Bottom Perspective View of the exterior housing of the invention.

FIG. 2 is a Side View of the exterior housing of the invention.

FIG. 3 is a Schematic View of how the device works.

FIG. 4 is a Side, Cut-Away view of the internal parts of the device.

### DETAILED DESCRIPTION OF THE FIGURES

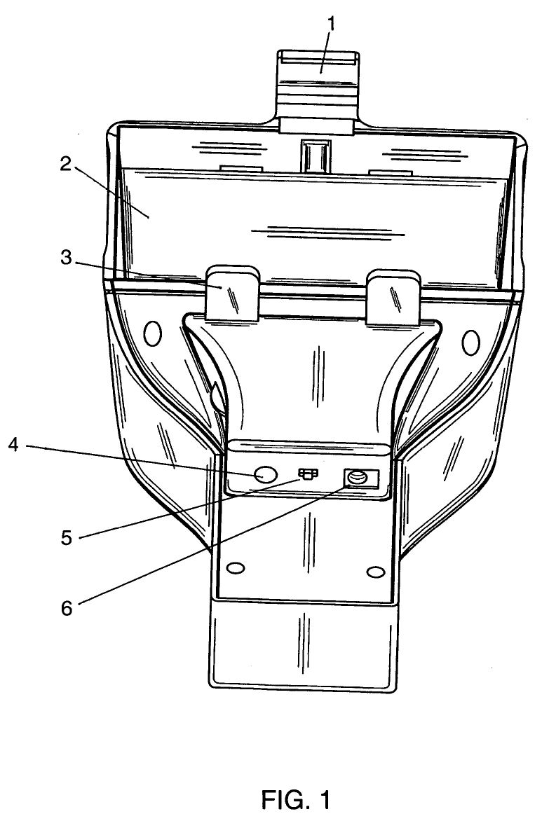

FIG. 1 a Bottom Perspective View of the exterior housing of the invention. The invention has two sets of clips (1 and 3) which are used to removably attach the invention to a handheld video game device or handheld video player. The screen of the handheld emits an image which is reflected by a mirror (2) to a camera (not shown in this figure). After being processed into a video signal, the image is transmitted to the exterior of the housing of the invention, which has a DC-in receptacle (4), a game/movie selection button (5), and an AV-out receptacle (6), through which the video image is transferred to a remote viewing screen such as a television or computer monitor.

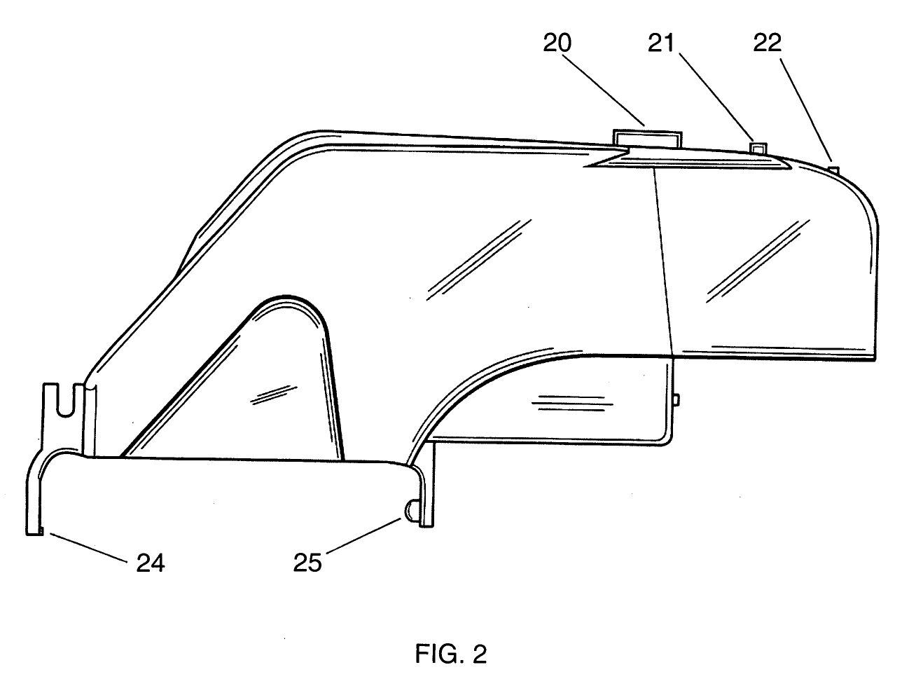

FIG. 2 shows a side view of the outer housing. The invention sits on top of a handheld and has a plastic console “holder” for easy installation. The unit clips on top of the handheld, shown here in the shape that fits onto a Sony PSP, but the invention is equally applicable to other handhelds—both handheld video game devices and handheld video players—and has two screws that fit into the back of the handheld (with the Sony PSP, into the two holes just above the UMD drive). While an iteration of the invention that fits onto a Sony PSP handheld is used for illustrating this figure, it should be noted that the invention can work equally well with a wide variety of other handheld video game devices and handheld video players, such as the Nintendo GameBoy line, NDS, Ipod video player, and others. The invention has two clips (24 and 25) which removably attach the invention to a handheld, and several control buttons on the top of the invention, including a power on/off button (20), a focus adjustment (21), and a green status LED (22).

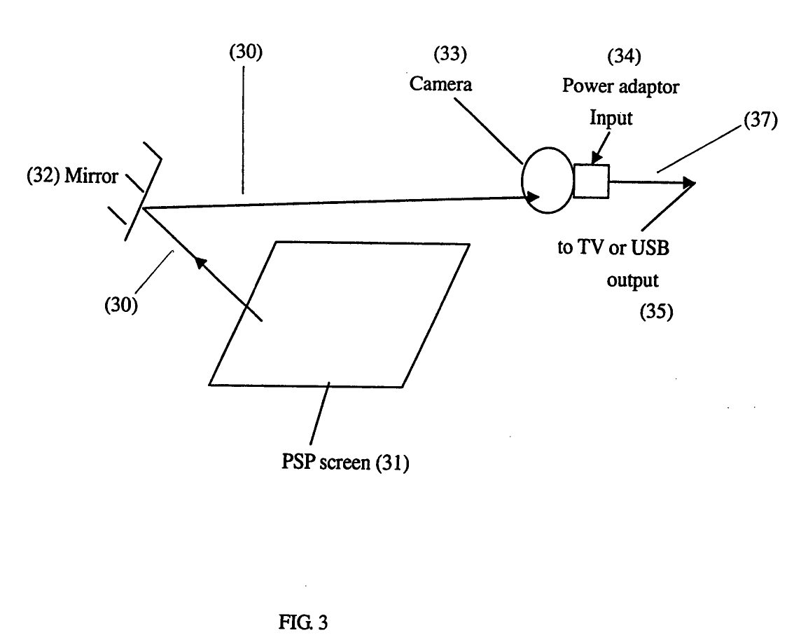

FIG. 3 is a Schematic View of how the device works in its iteration where a mirror is used to reflect the light. It should be noted that the invention also encompasses an iteration where the image from the screen is captured directly by the camera. This iteration is not shown as it is very similar to the mirror version shown here, without the mirror and with the camera having a direct line of sight to the screen of the handheld. There is an image on the screen of the handheld (31), shown here as a PSP. The image is projected through light beams (30) to a mirror (32), which reflects the light beams (30) into a camera (33), which captures of the image. A power adaptor input (34), attached to the camera, transforms the captured image into a video signal which is then transmitted via a cable (37) to a TV or USB output (35).

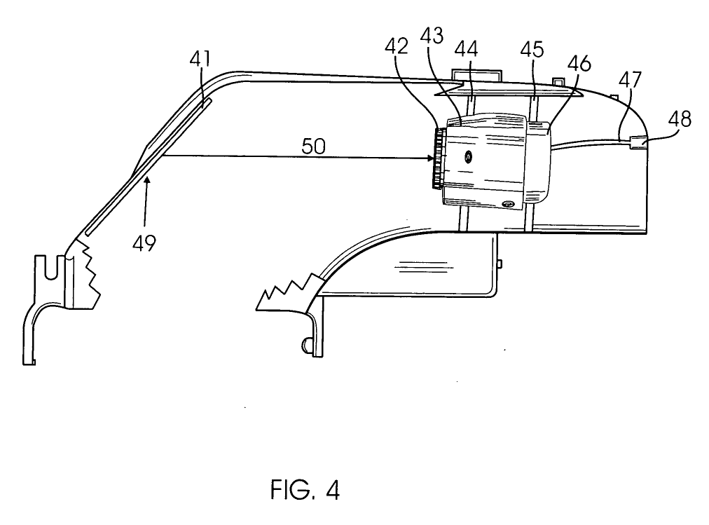

FIG. 4 shows the internal workings of the invention. The invention sits on top of a handheld and the screen image (49) of the handheld is reflected by an optionally adjustable mirror (41) into an optionally adjustable camera (43), secured to the body of the invention by optionally adjustable means of attachment (44), with an optionally adjustable lens (42), which captures the reflected image (50) and transforms it into a video signal, which is then transmitted through a power adaptor input (45), secured to the body by means of attachment (45) and through one or more cables (47) to one or more receptacles (48), such as a USB connection, which allow for a cable or other means of connection through which it can be projected onto a computer monitor, television screen, or other remote viewing screen separate from the image seen on the handheld. The camera can be made with one or more modes, including CMOS and CCD. The device also has a switch button which can be used to focus the image and to adjust the brightness. The invention also has a switch by which the user can switch between NTSC and PAL television systems, such that the device can be used on TV sets in almost all the countries in the world. The device optimally runs off a 12V power supply, but can also run off standard AC/DC and batteries. It should be noted that the invention can also be made without the mirror (41), such that the camera (43) points directly at the image from the handheld.

What I claim is:

1. A device for capturing an image from a handheld video game device or handheld video player and projecting it onto a screen external to the handheld, comprising:
a housing which can be temporarily affixed to the handheld video game device or handheld video player,
a camera into which the image of the screen of the handheld video game device or handheld video player is reflected by the mirror and inside of which the image is transformed into a video signal,
a means of transforming the video image into a video signal,
a power adaptor input which takes the video signal from the camera and transmits it to a viewing screen, where the viewing screen is not the same screen as the image from the handheld video game device or handheld video player,
a means of transmitting the video signal from the camera to the viewing screen, and,
a power supply, where, the device can capture the image from a handheld video game device or handheld video player and project it onto the screen without requiring a user of the device to open the handheld video game device or handheld video player.

2. The device of claim 1, additionally comprising a mirror which reflects the image of the screen on the handheld video game device or handheld video player.

3. The device of claim 1, where, the screen is a television screen.

4. The device of claim 1, where, the screen is a computer monitor.

5. The device of claim 1, where, the camera has more than one mode.

6. The camera of claim 5, where, the camera has at least the following modes: CMOS and CCD.

7. The device of claim 1, additionally comprising a switch button to adjust focus.

8. The device of claim 1, additionally comprising a switch button to adjust brightness.

9. The device of claim 1, additionally comprising a button to switch between NTSC and PAL.

10. The device of claim 1, where the housing additionally comprises a plastic console holder for installation which includes some combination of clips and/or screws by which the device attaches to the handheld.

11. The device of claim 1, where the power supply is 12V DC.

12. The device of claim 1, where the power supply is AC/DC.

13. The device of claim 1, where the means of transmitting the video signal from the camera to the screen is a cable.

14. The device of claim 1, where the camera has the capability of sending out the video signal in the form of one or more of the following forms: Svideo, VGA, AV, NTSC/PAL, and USB.

15. The device of claim 1, where the means of transforming the video image into a video signal is located inside the housing.

16. The device of claim 1, where the means of transforming the video image into a video signal is located inside the camera.

17. A method for capturing an image from a handheld video game device or handheld video player and projecting it onto a screen external to the handheld, comprising:
a first stop of taking a device for capturing an image from a handheld video game device or handheld video player and projecting it onto a screen external to the handheld, where the device comprises:
a housing which can be temporarily affixed to the handheld video game device or handheld video player,
a mirror which reflects the image of the screen on the handheld video game device or handheld video player,
a camera into which the image of the screen of the handheld video game device or handheld video player is reflected by the mirror and inside of which the image is transformed into a video signal,
a means of transforming the video image into a video signal,
a power adaptor input which takes the video signal from the camera and transmits it to a viewing screen,
a means of transmitting the video signal from the camera to the viewing screen, and,
a power supply, where,
the device can capture the image from a handheld video game device or handheld video player and project it onto the viewing screen without requiring a user of the device to open the handheld video game device or handheld video player,
a second step of attaching the device for capturing an image from a handheld video game device or handheld video player and attaching the device to the handheld video game device or handheld video player, and,
a third step of turning the device for capturing an image from a handheld video, game device or handheld video player on, turning the television or computer monitor on, turning the handheld video game device or handheld video player on, and watching the screen image from the handheld video game device or handheld video player on the television or computer monitor.

18. The method of claim 17, where the screen of the device for capturing an image from a handheld video game device or handheld video player and projecting it onto a screen external to the handheld is a television screen.

19. The method of claim 17, where the screen of the device for capturing an image from a handheld video game device or handheld video player and projecting it onto a screen external to the handheld is a computer monitor.

20. A device for capturing an image from a handheld video game device or handheld video player and projecting it onto a screen external to the handheld, comprising:
a housing which can be temporarily affixed to the handheld video game device or handheld video player,
a device which captures the image of the screen on the handheld video game device or handheld video player,
a device into which the image of the screen of the handheld video game device or handheld video player is directed by the device which captures the image of the screen on the handheld video game device or handheld video player and inside of which the image is transformed into a video signal,
a means of transforming the video image into a video signal,
a device which takes the video signal from the camera and transmits it to the screen,
a means of transmitting the video signal from the camera to the screen, and,
a power supply, where, the device can capture the image from a handheld video game device or handheld video player and project it onto the screen without requiring a user of the device to open the handheld video game device or handheld video player.
